(19) United States
(12) Patent Application Publication
(10) Pub. No.: US 2008/0040748 A1
(43) Pub. Date: Feb. 14, 2008

(54) Dynamic rating of content

(76) Inventor: Ken Miyaki, San Diego, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 11/502,265

(22) Filed: Aug. 9, 2006

(51) Int. Cl. H04N 5/445; H04N 7/10; H04N 7/025; H04N 7/16; G06F 3/00; G06F 13/00

(52) U.S. Cl. 725/46; 725/30; 725/34; 725/35

(57) ABSTRACT

A dynamic rating for content, such as video games, movies and music, is determined in accordance with profiles of users that access the content and provide evaluations of the content. The user's profile information and their evaluations are aggregated to determine a community based rating for the content. The rating may be accessed by users within the community, and content being accessed by a user in the community may be restricted or adjusted in response to profile data of the user and the corresponding rating of the content. This Abstract is provided for the sole purpose of complying with the Abstract requirement rules that allow a reader to quickly ascertain the subject matter of the disclosure contained herein. This Abstract is submitted with the explicit understanding that it will not be used to interpret or to limit the scope or the meaning of the claims.

### FIELD OF THE INVENTION

The present invention relates generally to rating of content and, more particularly, to dynamically rating content.

### BACKGROUND OF THE INVENTION

Growth of the entertainment industry has introduced new challenges for the industry in trying to ensure that appropriate content is available to different categories of individuals. For example, certain content, such as violent or sexual content, may be considered inappropriate for segments of a community, such as children, but may be considered appropriate if adults desire the content.

One solution to limiting access to certain types of content is to provide a rating system that identifies the type of content, and the members of the community for which the particular content is deemed acceptable. The motion picture industry has long employed such a rating system, where movies are classified as suitable for everyone, a rating of “G”, or only suitable for individuals over seventeen years of age, a rating of “R”, etc. This type of rating system is effective for the motion picture industry where it is possible to regulate who enters the theater and is able to view the content. But, this type of rating system is less effective when content is viewed at home, such as pay to view movies, or video games.

The entertainment software industry has attempted to address regulation of content by establishing an Entertainment Software Rating Board (ESRB) system. The ESRB ratings are designed with the goal of providing the community accurate and objective information about the content in computer and video games. The hope is that the ESRB will allow the public to make an informed purchase decision.

While the ESRB rating provides some guidance as to the content of computer and video games, it is a static rating system. That is, the ESRB members will review the content as submitted, or originally distributed, to establish a corresponding rating. However, electronic content can be changed after it is distributed. For example, a customer may purchase a video game with a rating that is appropriate for their child, but while the child is playing the game, they may go on-line and download new content for the game that is not appropriate.

In like manner the Motion Picture Association of America (MPM) recommends ratings for movies. In some environments is may be advantageous to provide alternate content for sections not suitable for children. For example, in-flight viewing of premium movies provides entertainment for travelers on long journeys. In this environment, movies selected by an airline should contain no content that could be offensive to parents, or inappropriate for young travelers. It would be advantageous to provide versions of movies that have been edited, to delete or modify portions of content. In this regard, it would be important to rate scenes of a movie individually.

Thus, there is a need for an improved, more efficient, rating system for content. The present invention satisfies this need.

### SUMMARY OF THE INVENTION

In accordance with the invention methods and apparatus for dynamic rating and enforcement of content is provided. In one embodiment, user profile information and feedback about the content or a portion of the content from a group of clients within a community is received. The profile information and feedback is aggregated into corresponding rating information of the content for the community. The rating information is then provided to members in the community.

Examples, of content include a video game, a movie, music, or other types of entertainment content. Collecting the feedback may be performed on-line. Also, aggregating the feedback may include weighting the feedback in accordance with a source of the feedback. For example, the weighting may take into account the length of time the source has been associated with the community, or if the source is a provider of the content. In addition, the ratings may be adjusted based upon, for example, the geographical location of the community, or cultural features of the community.

In another embodiment of dynamic rating of content, profile information about a user and evaluation information about the content, provided by the user, is collected. The profile information and their feedback or “rating data” is communicated to one or more servers. Examples of types of user profile information that may be collected include a user's age, a user's gender, and a user's geographic location. The profile information and rating data may be communicated to the server(s) over a network. The content may include a video game, a movie, or other types of entertainment content.

In yet another embodiment of dynamic rating of content, rating data for sections of the content are received. Profile information of a user that wants access to the content is collected. Access to the content is allowed based on the profile information. In a further embodiment, the content provided to the user is adjusted in response to the profile information and rating corresponding to the section of content being accessed by the user. Examples of adapting the content provided to the user includes eliminating a section of content, or providing an alternative section of content.

In an embodiment, a user terminal may include a console configured to provide a user access to content and to receive rating data relative to the content. The user terminal may also include at least one input device configured to collect profile information about a user, and an output device configured to provide the content to the user, wherein the content is adapted in response to the rating data and profile information. Examples of input devices include a keyboard, mouse, image sensor, and audio sensors.

In still another embodiment one of a plurality of servers may include a network connection configured to receive user profile information and feedback data collected from a group of clients within a community, the feedback data may include rating information about entertainment content evaluated by the group. The server may also include a processor configured to aggregate the user data and provide feedback into a corresponding rating of the content for the community. The network connection may then provide rating information to the community.

Another embodiment includes a communication network with at least one server configured to receive user profile information and feedback about a source of content from a group of users within a community, wherein the server aggregates the feedback into a rating for the content. The communication network also includes a user terminal configured to collect and communicate the user profile information and feedback to the server and to receive the rating from the server. The user terminal adjusts the content accessed by the user in response to the rating and user profile.

These and other features and advantages of the present invention will be appreciated from review of the following detailed description of the invention, along with the accompanying figures in which like reference numerals refer to like parts throughout.

### BRIEF DESCRIPTION OF THE DRAWINGS

Various embodiments of the present invention taught herein are illustrated by way of example, and not by way of limitation, in the figures of the accompanying drawings, in which:

FIG. 1 is a block diagram of an exemplary system configured for dynamic rating of content;

FIG. 2 is a block diagram of an exemplary user terminal configured for dynamic rating of content;

FIG. 3 is a flow chart illustrating an embodiment for providing user feedback or use in dynamic rating of content;

FIG. 4 is a flow chart illustrating another embodiment for providing user feedback for use in dynamic rating of content;

5 FIG. 5 is a flow chart illustrating an embodiment for determining a rating of content dynamically;

FIG. 6 is a flow chart illustrating an embodiment of using a dynamic rating to adapt content;

FIG. 7 is a flow chart illustrating another embodiment of using a dynamic rating to adapt content and

FIG. 8 is a flow chart illustrating yet another embodiment of using a dynamic rating to adapt content.

It will be recognized that some or all of the figures are schematic representations for purposes of illustration and do not necessarily depict the actual relative sizes or locations of the elements shown. The figures are provided for the purpose of illustrating one or more embodiments of the invention with the explicit understanding that they will not be used to limit the scope or the meaning of the claims.

### DETAILED DESCRIPTION OF THE INVENTION

In the following paragraphs, the present invention will be described in detail by way of example with reference to the attached drawings. While this invention is capable of embodiment in many different forms, there is shown in the drawings and will herein be described in detail specific embodiments, with the understanding that the present disclosure is to be considered as an example of the principles of the invention and not intended to limit the invention to the specific embodiments shown and described. That is, throughout this description, the embodiments and examples shown should be considered as exemplars, rather than as limitations on the present invention. Descriptions of well known components, methods and/or processing techniques are omitted so as to not unnecessarily obscure the invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

The explosive growth in the entertainment industry has introduced new challenges to ensure that appropriate content is available to different categories of individuals. To address this need methods and apparatuses for dynamically rating content are described. In one example, video games, are currently rated by the Entertainment Software Rating Board (ESRB) and given a rating, such as “M” or “G” based upon the existing, or static, content of the game. Fundamentally, this is a single “combined” rating for the entire game, that is determined by a very small number of people, the people on the ESRB board.

Network connectivity changes the notion of “static content.” Content, such as games, may no longer be constrained to the static information originally distributed by the manufacturer. For example, a game manufacturer may burn content onto a disc, or CD, but that content can be modified later. With network connectivity, a user can download updates to the original game from the game manufacturer, or third party developers, making the static rating provided by the ESRB board a limited, or even misleading, rating.

Dynamic rating of content empowers users, such as parents and people actually playing the games, to review and rate different parts of the content. Rating by members of the community is preferable to a rating determined by a small group such as the ESRB because it provides the people most affected by the content, such as the parents of children who play the game, input into the rating of the content.

Dynamic rating also supports providing ratings to sections of the content rather than the entire content as a whole. For example, a game may have graphic “cut-scenes”, such as a “blood and gore in a zombie scene”, that might cause the entire game to be rated Mature, or “M”, by the ESRB rating system. But, using dynamic rating the community may decide that only the “blood and gore scene” of the game is offensive and deserving of the “M” rating with the remainder of the game suitable for everyone, a “G” rating. Using dynamic rating, the game, or a user terminal or game console, can download aggregated user feedback information from a central server, and for a given community declare a section to be rated “M”. Then, based upon a profile of a person playing the game, it may decide to skip a section or omit a feature. For example, if a child is playing a game, then sections of the game that are dynamically rated “M” by the community can be skipped, or modified, so that only appropriate material is presented to the child. In addition, features may be omitted or modified, such as video chat, if the members of the community have identified these features as being inappropriate for children.

By enabling the community with the ability to determine ratings for content, the rating can be self-policing based on the standards for that community. A community based rating system is preferred, in some respects, because different communities may consider different content inappropriate for its members. For example, what is considered violent in the United States may be different than what is considered violent in Japan. Countries may have different laws and regulations regarding content appropriate for different age groups.

Additionally, different regions of a country may have different standards. Dynamic rating of content allows for the content to have a rating based on the targeted communities own standards and opinions of what is appropriate content. Examples of some characteristics of a community that can be considered in determining a rating targeted to that community include geographic location where the targeted audience resides or associates itself with, the ethnic makeup of the community, as well as other cultural and demographic features of the community.

Other characteristics of a community that may help determine a rating can include religious beliefs and guidelines, group or club affiliations, the age or sex of the members of a community, or lists of explicit preferences of an individual or community.

Thus far the discussion has used video games as example content for using dynamic rating. It is envisioned that many other types of content can use dynamic rating. For example, movies, pay-per-view movies, music, audio files, downloaded video and image files, other types of entertainment content, and the like. Another type of content that may benefit from the dynamic rating of content methods provided herein may include content in multi-user chat rooms. Multi-user chat rooms are online cites where users gather to discuss different topics. Based on the preferences of the individual participants, certain filters may be invoked. For example, an adults only chat room may have no filters. In contrast, chat rooms appropriate for underage children may have significant vulgarity filters applied.

Entertainment feeds, such as television, may additionally benefit from dynamic rating of content. In one embodiment of the present invention individual preferences may cause an intervention such as a message displayed on the individual's screen that the content may not be suitable to their preferences. Certain groups of clubs may share common standards and wish to have similar ratings on content. For example, a viewer who is a member of People for the Ethical Treatment of Animals (PETA) may decide that content related to the food processing industry is offensive. When a live or pre-recorded program, is scheduled, a message such as “this program may contain content that may not be suitable for the viewer”, can be displayed on screens of individuals that have decided not to receive this type of content. In one embodiment of the present invention the content provider may seed the meta-data of content with information suitable for rating determinations to be made.

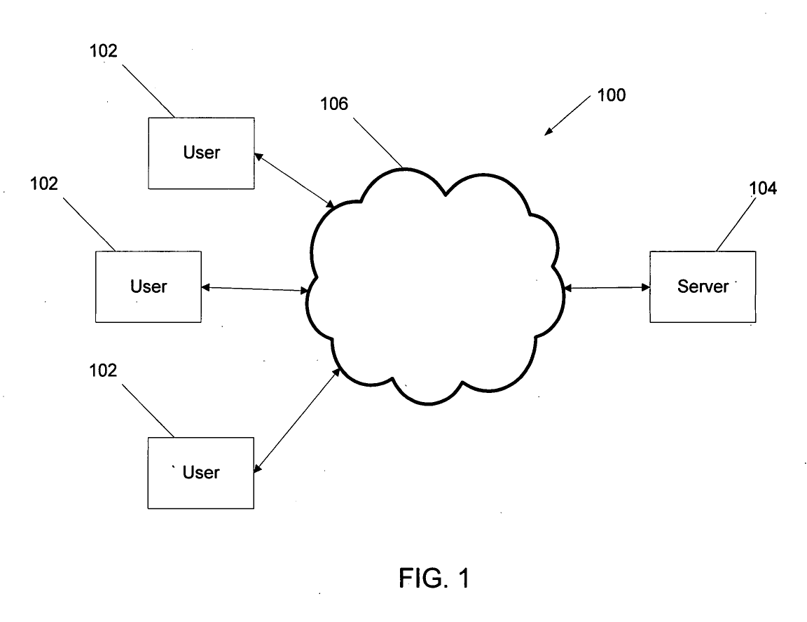

FIG. 1 is a block diagram of an exemplary system configured in accordance with one embodiment for dynamic rating of content. As illustrated in FIG. 1, the system 100 includes at least one user 102. Typically, when gathering rating information from a community there would be many users 102 in the system. The system 100 also includes server 104 and network 106. Network 106 may comprise a wireless network 106, a local area network 106, a metropolitan area network 106 a wide area network 106, or any other network 106 such as the Internet. Network 106 provides connectivity between users 102 and server 104. A network 106 as described herein may be a distributed network 106 in that a number of servers 104 may be used in the network 106. This embodiment has the advantage of scalability as the number of users 102 grows, the network 106 may add additional servers 104.

As used herein the terms “wireless network” may include, but are not limited to, long range wireless networks like cellular networks that may involve wireless data transfer technologies similar to General Packet Radio Services (GPRS) and Enhanced Data GSM Environment (EDGE). Additional examples of longer range wireless technologies may include, but are not limited to, wireless metropolitan area network technologies like WiMax, which is currently based on the IEEE 802.16 standard. The terms “wireless network” may additionally refer to Wireless Local Area Network (WLAN) technologies such as those based on the IEEE 802.11 family of standards. Further, the term “wireless network” may also include Wireless Personal Area Network (WPAN) technologies such as those specified by the BLUETOOTH special interest group, or alternatively Ultra Wideband. Additionally, it is anticipated that a “wireless network” as described herein may employ a number of communications technologies. It shall be understood that the specific wireless network technologies mentioned herein are merely exemplars of different wireless network technologies. The present invention is not limited with respect to the specific technology or combination of technologies employed by a wireless network.

As described further below rating information about the content, or portions thereof, is sent from users 102 to server 104. Server 104 collects profiles about the various users 102 along with the user 102's rating of the various portions of the content. This rating may vary across different portions of the entire content. Server 104 may then aggregate the profile and rating information and determine a community based rating for individual portions of content. Server 104 may then forward the aggregate rating to users 102 in the corresponding targeted communities. Client devices 200 of users 102 in the respective communities may use the aggregate rating to modify, or adjust, the content in response to the rating and the profile of the individual that is currently accessing the content. One feature of this embodiment is that one community may rate a portion of content differently than another community.

Communities may be significantly diverse. These communities may be based on location, or may be based on ethnicity, national origin, or job. Content available to a military community may be different than content available to a civilian community. In like manner content available to prisoners may be different than content available to school children. Additionally, the suitability of the content across these different communities may vary widely with the age of the users 102 that make up the community. Another feature of the present invention is it allows content to be rated for locality. For example, content suitable for viewing in a private residence may not be suitable for viewing in a public or government building or on a public transportation vehicle such as an airplane. This suitability may be independent of the profile information of any specific user 102.

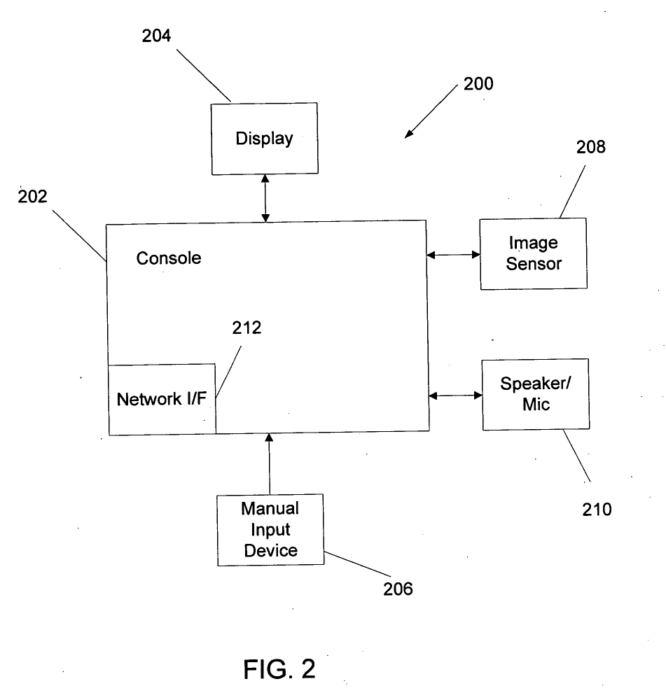

FIG. 2 is a block diagram of an exemplary user 102 client device 200 configured for dynamic rating of content consistent with one embodiment of the present invention. As shown in FIG. 2, client device 200 may include console 202, and display 204. The client device 200 may optionally include a manual input device 206, an image sensor 208, and a speaker and microphone 210. In one embodiment, the console 202, display 204, manual input device 206, image sensor 208, and speaker and microphone 210 are all combined into a single unit. In other embodiments some, or all, of the devices may be separate. The console 202 may also include a network interface 212. The network interface allows information to be exchanged between the user terminal 200 and server 104.

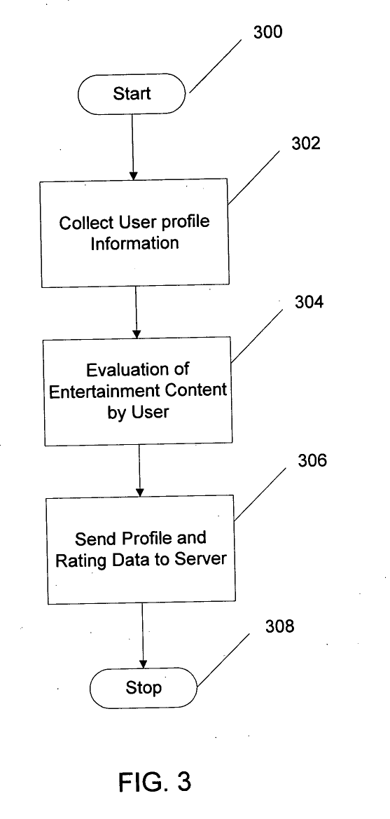

FIG. 3 is a flow chart illustrating an embodiment for providing user feedback for use in dynamic rating of content. In this embodiment, a user may be using a client device 200 as described in FIG. 2, Flow begins a block 300. Flow continues to block 302 where user profile information is collected. User profile information may be collected in many different ways. For example, the user may manually input data about themselves, or the data can be obtained from analysis of audio or imagery data of the user collected by the user terminal. Additionally, profile information may be collected from the user 102's history of content access. In another embodiment, the user 102 may provide explicit preferences that may be included in the profile information.

Flow continues to block 304 where the user evaluates content. The user may provide evaluations for multiple portions of the content. For example, the user may evaluate individual scenes of the content and provide a separate rating for each of the scenes. Likewise, the user may evaluate the content and only provide a rating for a scene if the user desires, and provide no rating for other scenes. Flow continues to block 306 where the user's profile and rating data are sent to a server. Flow continues to block 308 where flow stops.

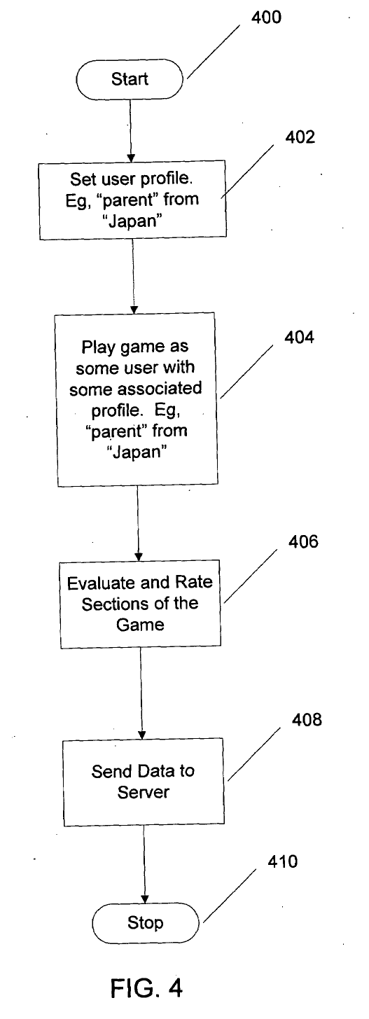

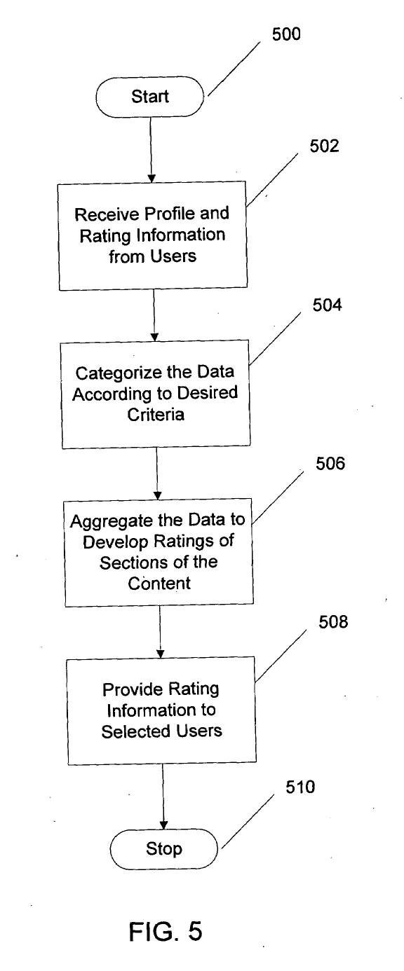

FIG. 4 is a flow chart illustrating another embodiment for providing user feedback for use in dynamic rating of content. Flow begins in block 400. Flow continues to block 402 where a user's profile is set. For example, the user profile may be set that the user is a “parent” from “Japan.” Flow continues to block 404 where the user plays a game. Flow continues to block 406 where the user rates sections of the game. Then in block 408 the ratings and the associated user profile data is sent to a server. Flow stops in block 410.

FIG. 5 is a flow chart illustrating an embodiment for determining a rating of content dynamically. Flow beings in block 500. In block 502 rating and profile data from users are received. For example, a server 104 connected to a network 106 may collect rating and profile data from multiple users 102 that are also on the network 106. Flow continues to block 504 where the information is categorized according to a desired criteria. For example, the data may be categorized according the content evaluated, user 102 profile data, such as age of user 102, location of user 102, nationality of user 102, religion of user 102, group affiliation of user 102, club affiliation of user 102 etc. In block 506 the categorized information is aggregated and a rating developed for the content. The rating may be to individual portions, such as specific scenes, of the content. Also, aggregating the feedback may include weighting the feedback in accordance with a source of the feedback. For example, the weighting may be adjusted in response to the length of time the source has been associated with the community, or is the source is a provider of the content.

In block 508 the ratings are provided to the users 102. The rating can be provided to all users 102, or to a subset of users 102, for example, based upon the community where the user 102 is a member. For, example, all users 102 in a particular location, such as country or region of a country, may receive one set of rating and users in a different location may receive a different set of ratings. Other locations where ratings could be different may include a military installation, a government building, a prison, a school, a public transportation vehicle, and a private residence. Alternatively, ratings to different groups of users may be based upon other characteristics of a community, such as ethnic background, age, gender, and the like.

In addition, if a particular user 102 has provided ratings for particular content, then that user 102 may receive ratings based upon their individual input rather than a community based rating. For example, if a particular user 102 rated scenes in a particular game as inappropriate for a child, then that user 102 could receive a rating based upon their individual input, even if the community as a whole believes that the scenes were appropriate for children. In this way an individual user 102 may control their unique rating and not be forced to accept a community rating. Flow continues to block 510 and stops.

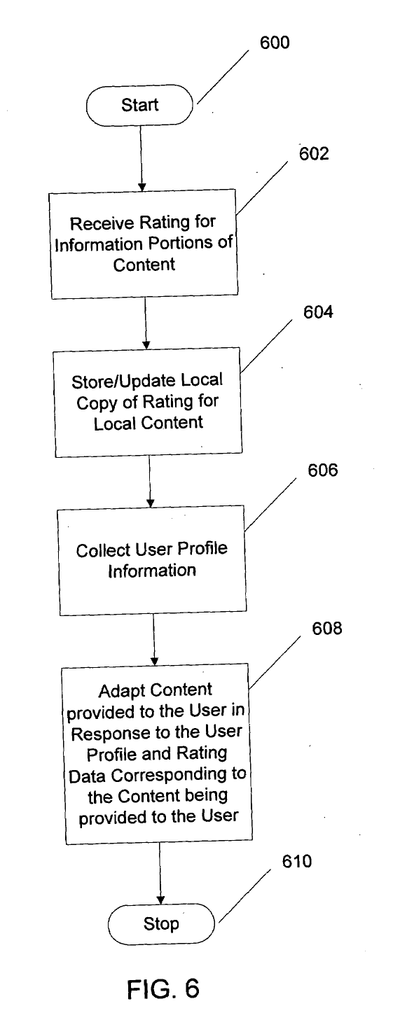

FIG. 6 is a flow chart illustrating an embodiment of the present invention using a dynamic rating to adapt content. Flow begins in block 600. In block 602 rating information is received for portions of content. For example, a user 102 at a client device 200, such as described in FIG. 2, may receive ratings for scenes of content, such as games, that are on the client device 200. The ratings received may be for multiple different contents, such as ratings for all of the games that are on the user's client device 200. The ratings may be received from a server via a network.

Flow continues to block 604. In block 604, the ratings are stored in the client device 200. The ratings may update a local copy of a previous rating for content, if the rating has changed from a previous rating. Again, the ratings for multiple different contents may be updated, such as, all of the different contents on the user's client device or all of the different contents available from a particular manufacturer, or a particular developer or al content of a particular rating that may be available for purchase on network 106. For example, ratings for all of the games on a user's client device 200 may be updated, or ratings for all games made by a particular manufacturer, or game developer, may be updated.

In block 606 user 102 profile information is collected. User 102 profile information may be collected in many different ways. For example, the user 102 may manually input information about themselves, or the information can be obtained from analysis of audio or imagery data of the user 102 collected by the client device 102.

In block 608 the content provided to the particular user 102 is adapted, or modified, in response to the user 102 profile and the rating information corresponding to the content being provided. After the content has been adapted, or modified, and provided to the user 102, flow stops in block 610. Adaptation or modification may take place in a myriad of ways, including removal of objects or scenes, muting audio profanity, scrambling text, covering sexual images, replacement of audio, text, graphics, etc.

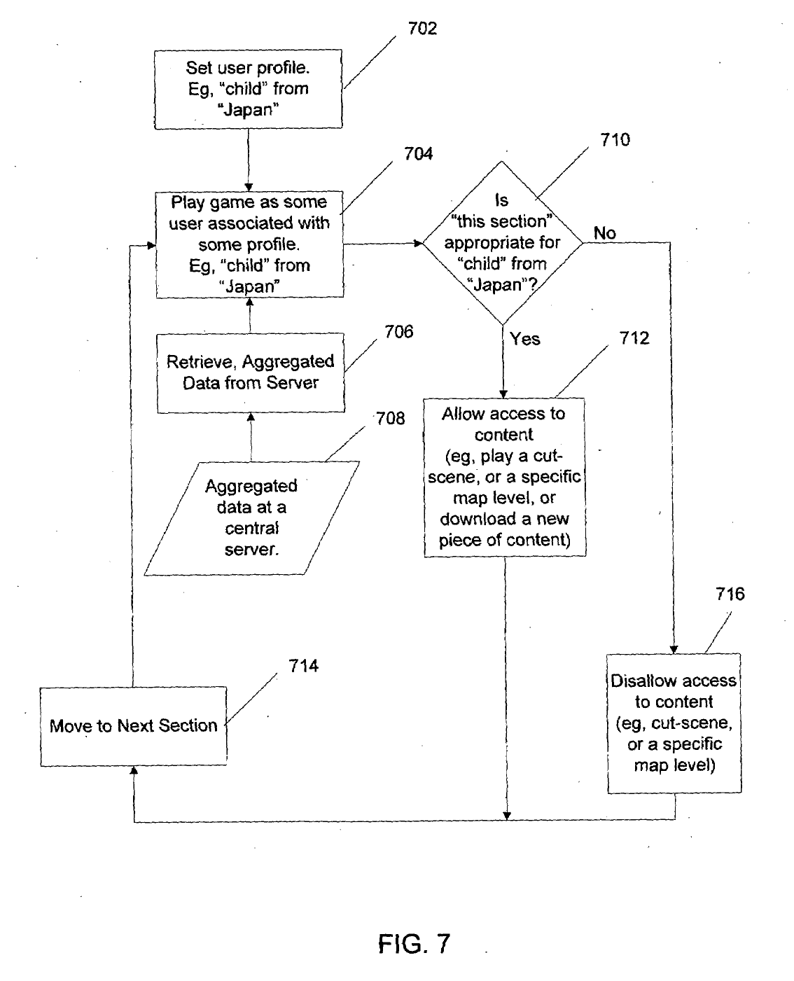

FIG. 7 is a flow chart illustrating another embodiment of using a dynamic rating to adapt content. In the embodiment of FIG. 7, a user 102 profile is set in block 702. For example, the user 102 profile may indicate the age of the user 102, such as a child under 10, and the country they are in, such as Japan. Flow continues to block 704. In block 704, the user 102 accesses the content. For example, the user 102 may play a game. In block 704, aggregated data form server 104 is retrieved from block 706. The aggregated data may be retrieved from data stored on server 104 at block 708.

Flow continues from block 704 to block 710. In block 710, it is determined if a particular section of content is appropriated based upon the user 102 profile information and rating corresponding to the particular section of content. In the example of FIG. 7, it is determined if the section of content is appropriate for a child from Japan. If the content is appropriate for the user 102, a positive outcome, flow continues to block 712. In block 712 the user 102 is allowed access to the content. For example, a cut-scene may be played, or a specific map level may be accessed, or a new piece of content may be downloaded. Flow then continues to block 714 and the user 102 moves to the next section of the content.

Returning to block 710, if the content is not appropriate for user 102 then flow continues to block 716. In block 716, user 102 is denied access to the content, or user 102 is allowed access to a different version of the content. Flow then continues to block 714 and user 102 moves to the next section of the content. From block 714, flow continues to block 704 and user 102 continues accessing the content.

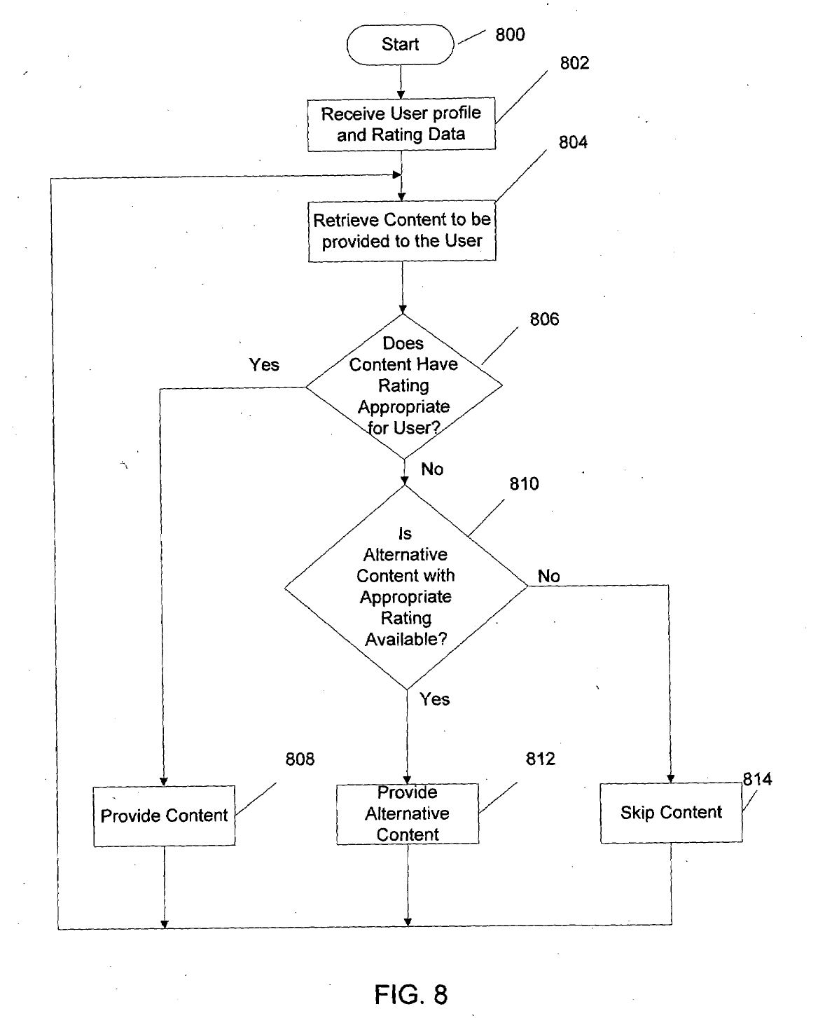

FIG. 8 is a flow chart illustrating yet another embodiment of using a dynamic rating to adapt content. Flow begins in block 800. In block 802 user 102 profile information and rating information is received. As discussed, user 102 profile information may be collected in many ways, such as manual input, or analysis of audio or image data of user 102. Flow continues to block 804 where content to be provided to user 102 is retrieved. Flow continues to block 806.

In block 806 it is determined if the content has a rating appropriate for user 102 accessing the content based upon the user 102 profile information and the rating of the content. If the content is appropriate, a positive outcome, flow continues to block 808 and the content is provided to user 102. Flow continues to block 804 and the next section of content to be provided to user 102 is retrieved.

Returning to block 806, if it is determined that the content has a rating that is inappropriate for user 102 flow continues to block 812. In block 812 it is determined if there is alternative content with an appropriate rating that is available to replace the inappropriate content. If there is alternative content available, a positive outcome, flow continues to block 812 and the alternative content is provided to user 102. Returning to block 810, if it is determined that there is no alternative content available, a negative outcome, flow continues to block 814 and the content is skipped, and not provided to user 102. Flow from blocks 812 and 814 then continues to block 804 and the next section of content to be provided to user 102 is retrieved.

Thus, it is seen that apparatus' and methods for dynamic rating of content are provided. One skilled in the art will appreciate that the present invention can be practiced by other than the above-described embodiments, which are presented in this description for purposes of illustration and not of limitation. The specification and drawings are not intended to limit the exclusionary scope of this patent document. It is noted that various equivalents for the particular embodiments discussed in this description may practice the invention as well. That is, while the present invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims. The fact that a product, process or method exhibits differences from one or more of the above-described exemplary embodiments does not mean that the product or process is outside the scope (literal scope and/or other legally-recognized scope) of the following claims.

1. A method of dynamic rating of content, the method comprising:
receiving a plurality of profile information from a plurality of users within a community;
receiving a plurality of rating information related to a portion of content from the plurality of users;
aggregating the profile information and the rating information; and
providing a rating to the community.

2. The method of claim 1, wherein the portion of content comprises content selected from a group consisting of: an entertainment content, an audio file, a video file, a television program, multi-user chat room content, a video game, a movie, and a piece of music.

3. The method of claim 1, wherein the receiving steps comprise receiving from a network.

4. The method of claim 3, wherein the network comprises a network selected from a group consisting of a metropolitan area network, a wide area network, a wireless network, a local area network, and the Internet.

5. The method of claim 3, wherein the network comprises a plurality of clients.

6. The method of claim 3, wherein the network comprises a plurality of servers.

7. The method of claim 1, wherein the step of aggregating comprises weighting the rating information based on a source of the rating information.

8. The method of claim 7, wherein the weighting is adjusted in response to a parameter associated with the source of the rating information.

9. The method of claim 8, wherein the parameter comprises a parameter selected from a group consisting of a content provider parameter, a length of time of association with the community parameter, and an age parameter.

10. The method of claim 1, wherein the rating is adjusted in response to a location of the community.

11. The method of claim 10, wherein the location comprises a location selected from a group consisting of: a country, a region of a country, a commercial or retail * environment, a public area, a private area, a religious area, a military base, a government building, a prison, a school, an airplane, a bus, a public transportation vehicle, and a private residence.

12. The method of claim 1, wherein the rating is adjusted in response to cultural features of a community.

13. The method of claim 1, wherein the rating is adjusted in response to rules of the community.

14. The method of claim 13, wherein the rules comprise rules selected from a group consisting of community selected rules, community selected regulations, government laws, government regulations, and religious guidelines.

15. The method of claim 1, wherein the community comprises a community selected from a group consisting of: an ethnic community, a military community, a governmental community, a social community, a community defined by an a club affiliation, a community defined by a group affiliation, a prison community, a school community, and a religious community.

16. The method of claim 1, wherein the portion of content comprises less than the entire content.

17. The method of claim 16, wherein the content is selected from a group consisting of a video game, a movie, and a collection of music.

18. A method of dynamic rating of content, the method comprising:
rating a portion of content by a user;
collecting profile information about the user;
receiving rating information from the user;
communicating profile information and rating information to a server.

19. The method of claim 18, wherein the portion of content is less than the entire content.

20. The method of claim 18, wherein the content comprises content selected from a group consisting of: an entertainment content, an audio file, a video file, a television program, multi-user chat room content, a video game, a movie, and a piece of music.

21. The method of claim 18, wherein the profile information comprises a parameter selected from a group consisting of: a user age, a user gender, a user location, a user religion, a user group affiliation, a user club affiliation and a user preference.

22. The method of claim 21, wherein the user location comprises a location selected from a group consisting of: a country, a region of a country, a military base, a government building, a house of worship, a public building, a school, a prison, a public transportation vehicle, and a private residence.

23. The method of claim 18, wherein the step of communicating profile information and rating information is accomplished on a network.

24. The method of claim 23, wherein the network comprises a plurality of clients.

25. The method of claim 23, wherein the network comprises a plurality of servers.

26. The method of claim 23, wherein the network comprises a network selected from a group consisting of: a metropolitan area network, a wide area network, a local area network, a wireless network, and the Internet.

27. A method of content delivery, the method comprising:
receiving rating information about a portion of content;
collecting profile information from a user desiring access to the content;
adapting a portion of the content in response to the profile information; and
providing the adapted content to the user.

28. The method of claim 27, wherein the portion of content is less than the entire content.

29. The method of claim 27, wherein the portion of content comprises content selected from a group consisting of: an entertainment content, an audio file, a video file, a television program, multi-user chat room content, a video game, a movie, and a piece of music.

30. The method of claim 27, wherein the profile information comprises information selected from a group consisting of: a user age, a user gender, a user location, a user religion, a user group affiliation, a user club affiliation and a user preference.

31. The method of claim 30, wherein the location comprises a location selected from a group consisting of: a country, a region of a country, a military installation, a government building, a house of worship, a public building, a prison, a school, a public transportation vehicle, and a private dwelling.

32. The method of claim 27, wherein the step of adapting comprises eliminating or restricting access to all or part of the content.

33. The method of claim 27, wherein the step of adapting comprises replacing a section of content with alternate content.

34. The method of claim 27, wherein the step of providing the adapted content comprises providing the adapted content through a network.

35. The method of claim 32, wherein the step of adapting is based on restricting access to content and results to adapt the content to the values of a community.

36. The method of claim 34, wherein the network comprises a plurality of clients.

37. The method of claim 34, wherein the network comprises a plurality of servers.

38. A user client device comprising:
a console configured to provide a user access to content, the console further configured to receive rating information from the user;
at least one input device, communicating with the console, configured to collect profile information about the user;
at least one output device configured to provide the content to the user, wherein the content is adapted in response to the rating information and the profile information.

39. The device of claim 38, wherein the rating information is rating information related to a portion of the content.

40. The device of claim 39, wherein the portion of the content is less than the entire content.

41. The device of claim 38, wherein the content comprises content selected from a group consisting of: an entertainment content, an audio file, a video file, a television program, multi-user chat room content, a video game, a movie, and a piece of music.

42. The device of claim 38, wherein the at least one input device is a device selected from a group consisting of: a keyboard, a mouse, an image sensor, and an audio sensor.

43. The device of claim 38, wherein the profile information comprises information selected from a group consisting of: a user age, a user gender, a user location, a user religion, a user group affiliation, a user club affiliation and a user preference.

44. The device of claim 43, wherein the location comprises a location selected from a group consisting of: a military installation, a government building, a public building, a prison, a school, a house of worship, a public transportation vehicle, and a private dwelling.

45. The device of claim 38, wherein the at least one output device comprises a device selected from a group consisting of: an audio output device, a video game console, and a video monitor.

46. The device of claim 38, wherein the adaptation to the content comprises replacing a portion of the content.

47. The device of claim 38, wherein the adaptation to the content comprises elimination of a portion of the content.

48. The device of claim 38, further comprising a network connection.

49. The device of claim 48, wherein the network comprises a network selected from a group consisting of a metropolitan area network, a wide area network, a wireless network, and the Internet.

50. The device of claim 48, wherein the network comprises a plurality of client devices.

51. The device of claim 48, wherein the network comprises a plurality of servers.

52. A server comprising:
a network connection configured to receive a plurality of profile information from a plurality of users, the server further configured to receive a plurality of rating information from the plurality of users, the plurality of users comprising a community; and
a processor configured to aggregate the profile information and the rating information and create a rating for a portion of content for the community, wherein the network connection provides the rating to the community.

53. The server of claim 52, wherein the portion of content is less than the entire content.

54. The server of claim 52, wherein the content comprises content selected from a group consisting of: an entertainment content, an audio file, a video file, a television program, multi-user chat room content, a video game, a movie, and a piece of music.

55. The server of claim 52, wherein the configuration for aggregating profile and rating information comprises a configuration for weighting the rating information.

56. The server of claim 55, wherein the weighting is adjusted in response to the length of time the user has been associated with the community.

57. The server of claim 55, wherein the weighting is adjusted if the user is the provider of the content.

58. The server of claim 52, wherein the profile information comprises information selected from a group consisting of: a user age, a user gender, a user location, a user religion, a user group affiliation, a user club affiliation and a user preference.

59. The server of claim 58, wherein the location is selected from a group consisting of: a country, a region of a country, a military installation, a government building, a public building, a prison, a house of worship, a school, a public transportation vehicle, and a private dwelling.

60. The server of claim 52, wherein the rating is adjusted in response to cultural features of the community.

61. The server of claim 52, wherein the rating is adjusted in response to rules of the community.

62. The server of claim 61, wherein the rules comprise rules selected from a group consisting of: community selected rules, community selected regulations, government laws, government regulations, and religious guidelines.

63. The server of claim 52, wherein the community is selected from a group consisting of: an ethnic community, a military community, a governmental community, a social community, a community defined by a club affiliation, a community defined by a group affiliation, a prison community, a school community, and a religious community.

64. The server of claim 52, wherein the network connection is connected to a network comprising a network selected from a group consisting of: a metropolitan area network, a wide area network, a local area network, a wireless network, and the Internet.

65. The server of claim 52, wherein the network connection is connected to a network comprising a plurality of clients.

66. The server of claim 52, wherein the network connection is connected to a network comprising a plurality of servers.

67. A communication network comprising:
at least one server configured to receive a plurality of profile information and rating information about a portion of content from a plurality of users of a community, the plurality of users using a plurality of client devices, the server further configured to aggregate the profile information and the rating information into a rating for the portion of content; the plurality of client devices being configured to provide the plurality of profile information and the plurality rating information in response to input by the plurality of users, the plurality of client devices being further configured to adjust the content accessed by the plurality of users in response to the rating.

68. The network of claim 67, wherein the content comprises content selected from a group consisting of: an entertainment content, an audio file, a video file, a television program, multi-user chat room content, a video game, a movie, and a piece of music.

69. The network of claim 67, wherein the portion of content is less than the entire content.

70. The network of claim 67, wherein the adjustment to the content comprises eliminating a portion of the content.

71. The network of claim 67, wherein the adjustment to the content comprises replacing a portion of the content.

72. The network of claim 67, wherein the profile information comprises information selected from a group consisting of: a user age, a user gender, a user location, a user religion, a user group affiliation, a user club affiliation and a user preference.

73. The network of claim 62, wherein the location is selected from a group consisting of: a country, a region of a country, a military installation, a government building, a house of worship, a public building, a prison, a school, a public transportation vehicle, and a private dwelling.

74. The network of claim 67, wherein the rating is adjusted in response to cultural features of the community.

75. The network of claim 67, wherein the rating is adjusted in response to rules of the community.

76. The network of claim 67, wherein the rules comprise rules selected from a group consisting of community selected rules, community selected regulations, government laws, government regulations, and religious guidelines.

77. The network of claim 67, wherein the network comprises a network selected from a group consisting of: a metropolitan area network, a wide area network, a local area network, a wireless network and the Internet.
